(19) United States
(12) Patent Application Publication
(10) Pub. No.: US 2003/0064675 A1
(43) Pub. Date: Apr. 3, 2003

(54) Ventilated mixing station

(76) Inventor: Martin McCormick, Winnipeg (CA)

Correspondence Address: Mr. Adrian D. Battison, Ade & Company, 1700-360 Main Street, Winnipeg, MB, R3C 3Z3, CA

(21) Appl. No.: 09/964,368

(22) Filed: Sep. 28, 2001

(51) Int. Cl. F24F 7/00; F24F 11/00; F24F 13/00; F23J 11/00; F24C 15/20; B08B 15/02; B01F 15/00

(52) U.S. Cl. 454/56; 366/143; 366/347

(57) ABSTRACT

A work station suitable for use as a mixing station for paints includes a table with a hood mounted over the back edge of the table. Back and side walls of the table lead up to the hood. A downwardly sloping transparent panel extends over the front portion of the table so that materials being handled can be viewed from above while gaseous contaminants emitted by those materials are captured by the transparent cover and a vacuum applied to the hood.

The present invention relates to the collection of fumes and vapours and more particularly to a work station with this capability.

When using certain paint products, for example the coatings that are used for spray painting automobiles, the paint is mixed with a hardener just prior to use. This produces an exothermic reaction and the emission of noxious isocyanate gases. To limit the exposure of those mixing the paint to the isocyanates, the mixing is done at a mixing station that is designed to draw a high volume, high velocity air flow horizontally across the can in which the paint is being mixed. This is intended to capture the isocyanates while allowing the mixer to view the contents of the can from above.

Because the isocyanates are heated by the exothermic reaction, they rise. To capture these rising gases, the known mixing stations require very high flow rates. Because the flow is drawn from around the operator of the station, it is partially blocked and the capture may not be as thorough as desired.

Another requirement of a mixing station is an ability to contain a spill of paint. This is conventionally satisfied by making the table a tray, with side and back walls and a flange along the front. This is inconvenient as it requires the lifting of a paint can over the front flange when it is removed from the table.

The present invention is concerned with a ventilated work stations that ameliorate one or more problems with the prior art.

According to the present invention there is provided a mixing station comprising:

a table;

a back wall and two spaced apart side walls upstanding from the table;

a hood spaced above the table and extending along the back wall between the side walls and partially across the table from the back wall to a position spaced between front and back edges of the table;

a transparent panel extending along the table between the side walls and sloping downwardly from a front side of the hood to a front panel edge spaced above the front edge of the table,

whereby articles on the table are visible through the transparent panel and gaseous material rising from such articles are contained by the panel and hood.

The transparent panel sloping down over the paint can allows the operator to see the contents of the can while still capturing the warm gases and vapours rising from the can and directed into the hood at the rear. An exhaust fan of moderate strength can thus collect all of the emitted gaseous material.

It is preferred to include an extension of the table to one side, without the transparent panel. This allows the operator to carry out other operations that do not involve the generation of noxious gases. The hood preferably extends over the back portion of this extension to create a draft drawing in any fumes that may be released in this area.

It is further preferred that the table have a drain opening and a spill container below the drain opening, thus allowing the elimination of the flange along the front edge of the table.

In the accompanying drawings, which illustrate an exemplary embodiment of the present invention:

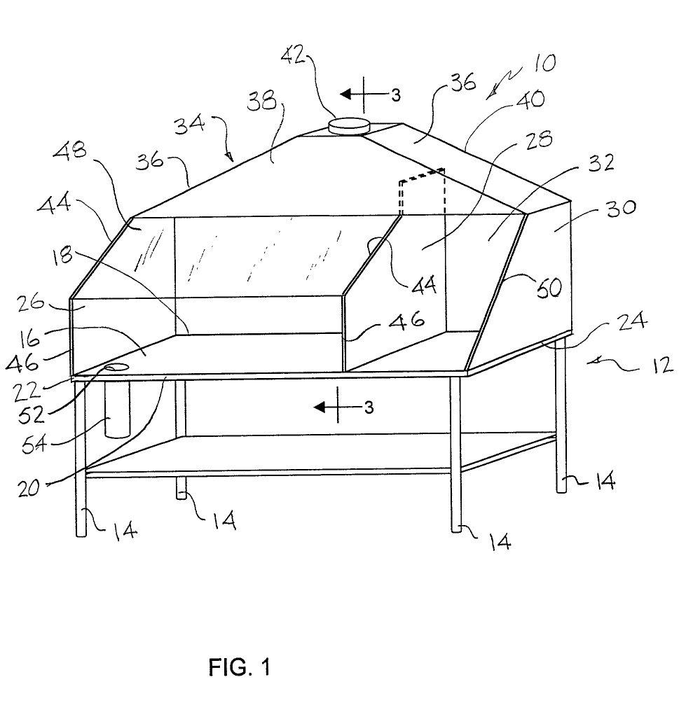

FIG. 1 is an isometric view of a work station according to the present invention.

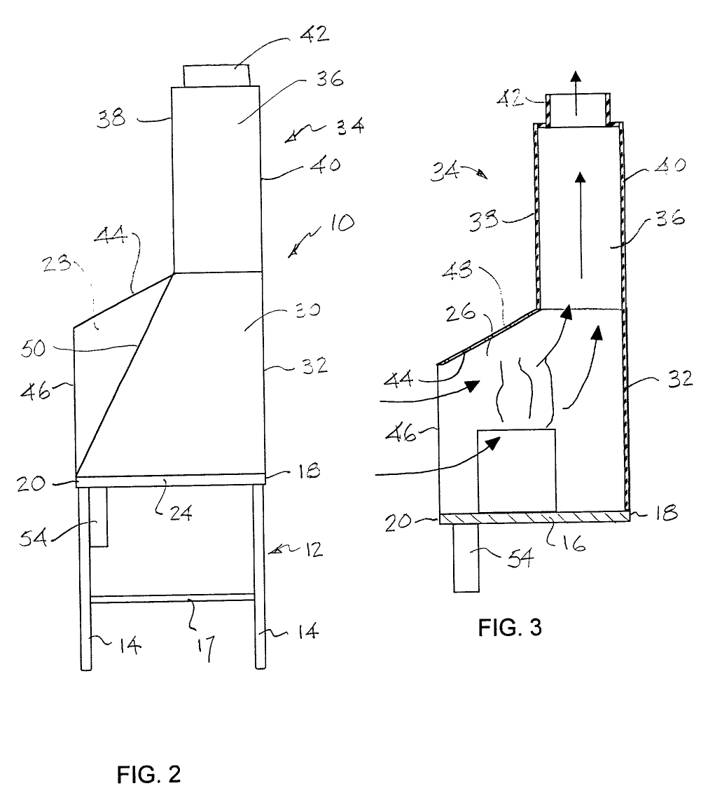

FIG. 2 is a side view of the work station.

FIG. 3 is a cross-section along line 3-3 of FIG. 1.

Referring to the accompanying drawings, there is illustrated a work station 10 particularly designed as a mixing station for mixing paints. The station includes a table 12 with four legs 14 at the corners and a rectangular table top 16. A shelf 17 below the table top joins the legs and provides additional stability as well as storage space.

The table top 16 has a back edge 18, a front edge 20 and opposite side edges 22 and 24. Upright side wall 26 is positioned at the side edge 22. A second upright side wall 28 is positioned partway along the table from the side wall 26. A third upright side wall 30 is positioned along table edge 24, parallel to the side walls 26 and 28. A back wall 32 extends along the back edge of the table top and is fixed to the back edges of the side walls 26, 28 and 30.

A hood 34 has two upwardly convergent side walls 36 leading from the tops of the side walls 26 and 30, a flat, vertical front wall 38 and a vertical back wall 40 that is an upwards extension of the back wall 32. At the top, the hood is connected to an extraction duct 42.

The side walls 26 and 28 have sloping top edges 44 that lead from the front, bottom edge of the front wall of the hood down to vertical front edges 46. A rectangular, transparent panel 48 is mounted in place between the side walls 26 and 28, extending from the front edge of the hood front wall 38 down to the vertical front edges 46 of the walls 26 and 30. For safety reasons the panel in this embodiment is a shatter-resistant glass.

As illustrated most particularly in FIGS. 1 and 2, the side wall 30 has an inclined front edge 50 that slopes downwardly from the hood front wall to the front edge of the table top 16. This provides an extension of the table to one side, without the transparent panel.

The table top 16 has a drain hole 52 near the front edge. This leads to a container 54 mounted below the table top for capturing any spilled paint products.

In use, a can of materials to be mixed is placed in the mixing station, under the transparent panel 48 so that its contents can be viewed. The mixing process is then commenced. Any vapours or gases rising from the can are contained by the sloping panel 48 and directed into the hood 34. Suction is applied to the duct 42 to draw these gaseous contaminants from the hood. Materials that are not emitting large quantities of noxious gaseous materials may be placed on that portion of the table between the side walls 28 and 30. The low pressure in the hood 34 will produce a flow of air and gas up into the hood from this part of the work station sufficient to carry small amounts of contaminant gases. The flow from this part of the work station is controlled with an upwards extension 56 of the partition wall 30 into the hood, limiting the gap between the top of the partition wall and the hood for drawing air from this part of the work station.

While one embodiment of the present invention has been described in the foregoing, it is to be understood that other embodiments are possible within the scope of the invention and are intended to be included herein. The invention is to be considered limited solely by the scope of the appended claims.

1. A mixing station comprising:
a table;
a back wall and two spaced apart side walls upstanding from the table;
a hood spaced above the table and extending along the back wall between the side walls and partially across the table from the back wall to a position spaced between front and back edges of the table;
a transparent panel extending along the table between the side walls and sloping downwardly from a front side of the hood to a front panel edge spaced above the front edge of the table,
whereby articles on the table are visible through the transparent panel and gaseous material rising from such articles are contained by the panel and hood.

2. A work station according to claim 1 including a drain opening in the table and a spill container positioned below the drain opening.

3. A work station according to claim 1 wherein the table includes a section extending beyond one of the side walls.

4. A table according to claim 3 including a further side wall along a side edge of the table remote from said one of the side walls, the back wall extending along a back edge of the table to the further side wall and the hood extending along the back wall to the further side wall.
